(19) United States
(12) Patent Application Publication
(10) Pub. No.: US 2012/0279378 A1
(43) Pub. Date: Nov. 8, 2012

(54) Rhythm & visual accessories for drumsticks

(76) Inventors: Kirk Neville Stamper, Mansfield, OH (US); Carla Jean Stamper, Mansfield, OH (US)

(21) Appl. No.: 13/068,254

(22) Filed: May 6, 2011

(51) Int. Cl. G10D 13/02

(52) U.S. Cl. 84/422.4

(57) ABSTRACT

Rhythm and visual effects produced through an array of accessories for drumstick(s), the accessories being implemented by use of attached connector(s) joining the accessories temporarily to the drumstick(s). The design for the connector(s) and accessories being small and lightweight so as not to interfere with a drummer's performance.

### CROSS-REFERENCE TO RELATED APPLICATIONS

This application claims the benefit of provisional patent application No. 61/343,822; Filed May 5, 2010; Titled: Quick sticks percussion tricks

### FEDERALLY SPONSORED RESEARCH OR DEVELOPMENT

Not Applicable

### SEQUENCE LISTING OR PROGRAM

Not Applicable

### BACKGROUND

1. Field

This application relates to the music industry in general and most specifically to percussion instruments.

2. Prior Art

Earliest recorded history indicates that musicians have always gathered together for the purpose of playing various musical instruments in the same place at the same time. Throughout the music field and since at least as far back as the arrival of the ‘one-man-band’, efforts have been made to enable an individual musician to produce simultaneous instrumental sounds. Several well-known devices now exist for this purpose. Harmonica holders enable an individual musician to play harmonica along with another hand-held or hand-manipulated instrument, such as guitar or piano; keyboards and electric pianos provide a musician with the capability of simulating several instruments concurrently; and various effects boxes enhance a guitar by layering its audio output to produce the sound of more than one guitar.

Specifically within the percussion area of musical instruments, efforts have been made to enable a drummer to add other rhythmic instrument sounds to the beat of the drums and cymbals. Yet, even with tremendous advances benefiting other instrumentalists in like manner, the prior efforts in the percussion art have failed to produced any design that has accomplished marketplace acceptance or notable success.

Various apparatuses have been designed in combination with, or to be attached to, a drumstick in attempts to accomplish the desired result. For example, U.S. Pat. No. 3,592,097 and U.S. Pat. No. 6,316,709, present designs for attaching cymbals to the exterior of a drumstick. However both are enormously bulky and because of their construction would have considerable weight, sufficient to cause a drummer to have to modify the grip of the drumstick and potentially be forced to otherwise compensate to prevent negative effects on personal style and potentially even rhythm. U.S. Pat. App. No. 20,100,058,919 shows tambourine jingles as a permanent part of a modified drumstick. Each of these above-referenced designs limits the drummer to having the jingles “′on′” and producing sound at all times without providing a method for the jingles to be turned “off” during play. Each of these designs is further limited by adding to the drumstick only one percussion sound.

U.S. Pat. No. D211,964, U.S. Pat No. D386,779, and U.S. Pat. No. D473,259 depict designs for mounting tambourine jingles or cymbals within a wooden stick. The products of these designs would be suitable for use as separate, hand-held, tambourine-type instruments, but are not well-suited to be used as drumsticks, and again offer only the ‘tambourine’ sound.

U.S. Pat. No. 5,044,250 claims a partially hollow drumstick with sounding pellets, which, while providing a percussion sound different from a tambourine, still limits the user to only one sound to be added to the drums and cymbals.

While U.S. Pat. No. 6,646,192 discloses a combination of a drumstick and a brush, once again having the limitation of providing only one sound. Of the aforementioned designs, none provides a drummer with the benefit of a range of options for various sounds.

Within the field of music it has been long-desired for musicians, and specifically percussionists, to have a means of accomplishing various simultaneous sounds. However, due to the foregoing limitations, the endeavors of the prior art simply have not possessed the necessary qualities to accomplish this task in any practical manner nor with significant success. Thus, drummers have, for all preceding time, been limited in their ability to achieve this much-sought-after outcome.

Additionally, within the prior art, drummers in marching bands have been especially restricted due to the necessity of their remaining entirely mobile during their performance. Certain allowances may be made by head band directors for marching band members to carry a choice of small auxiliary items with them while playing. However, the prior art has offered marching band drummers no such device with significant performance-enhancing abilities.

Further, in our technology-saturated environment, it has become essential for musicians to place increasingly greater value on their stage presence and visual presentation and therefore, there exists within the field a continuing need for innovative ways in which to enhance those aspects of one's performance.

Attempts within the prior art to enhance a drummer's performance by adding other rhythm sounds to the drumstick do not provide a range of options, they do not show flexibility for the drummer to change from not using to quickly using the product; most are not size and weight proportionate to be utilized in conjunction with a drumstick, nor do these prior efforts offer drummers the option of enhancing their visual performance. Hence, percussionists have remained limited.

### SUMMARY

The product design depicted in this application is comprised of multiple variations of a light-weight compact holder for a drumstick, baton, or similar item which can be quickly attached to and removed from a drumstick, or similar item. Each variation, in addition to the connector, has either a mechanism for producing a ‘visual trick’ or a version of a percussion instrument contained within its parts. Hence, percussionists, from the novice to the most accomplished, are thereby equipped to enhance “showmanship” or to add such sounds as may be comparable to, but not limited to, tambourine jingles; various brushes; maracas or ‘egg shakers’; jingle bells; or various mallets. Further, the gadget/connector provides the potential for additional benefits as would be applicable for different instruments. Accordingly, the brushes can be quickly modified to provide numerous options for adjusting the audio output, and the tambourine jingles have a dampening mechanism which can be engaged or disengaged while playing, enabling the drummer to drastically change the sound while maintaining a continuous beat. Moreover, in addition to the various gadget sounds being utilized along with the striking of a drum or cymbal, certain gadgets can be attached to drumstick(s) then used as instruments separate from the drums by being shaken, struck against a variety of other appropriate surfaces, or utilized by alternating with the drumbeat. An added, perhaps unanticipated benefit is the variation which provides a drummer with the ability to “twirl” a drumstick, thereby enhancing visual performance.

Musical percussionists, specifically drummers, shall no longer be limited in their ability to produce more than one rhythmic sound simultaneously, thereby enabling them to quickly modify their performance to accompany and enhance any genre of music. Each variation of the gadget/connector is small and lightweight allowing a drummer to utilize all of its benefits without any significant adjustment to the method of playing being necessary. Its compact size further increases probability of marching band drummers receiving benefit. Other marching band percussionists, playing such as instruments as the xylophone may benefit as well. It is expected that marching bands will make great use of the twirl. Further, this design will permit use with any size drumstick making the gadget/connectors a viable option for every drummer regardless of stick size preference.

The result accomplished by use of a gadget/connector is greater than would be accomplished by use of its separate parts. For example, a drummer, having benefit of the tambourine sound by means of another musician, would not be as probable to achieve perfect synchronization as could be achieved when the separate sounds are produced by an individual. More specifically, the greatest possible result by human means, without technological assistance such as digital synchronization, is achieved when the separate sounds are emitted by a device being held in one hand.

While previous attempts by others have been made to satisfy the lack that exists within the art, as compared to the gadget/connector, those prior attempts are inferior in perhaps all regards, at the least in performance, appearance, number of features, usefulness, and simplicity of use. Notably, the information obtained through the applicants' search for references of similar ideas within the relevant art has strongly indicated that the benefits made available through the gadget/connector as presented within this application, are both long-sought after by musicians, and completely novel and unprecedented within the field.

### DRAWING

### Brief Description Of Views

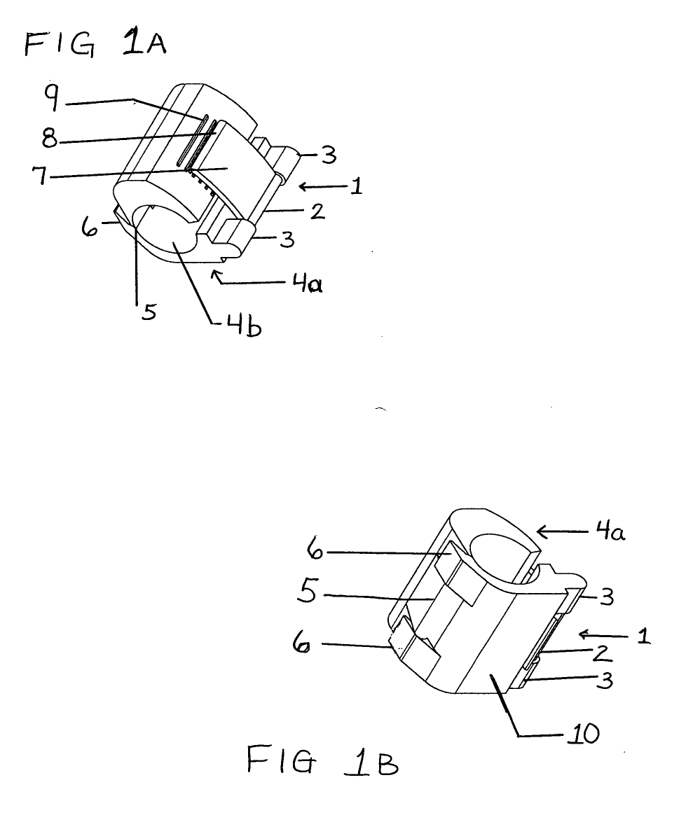

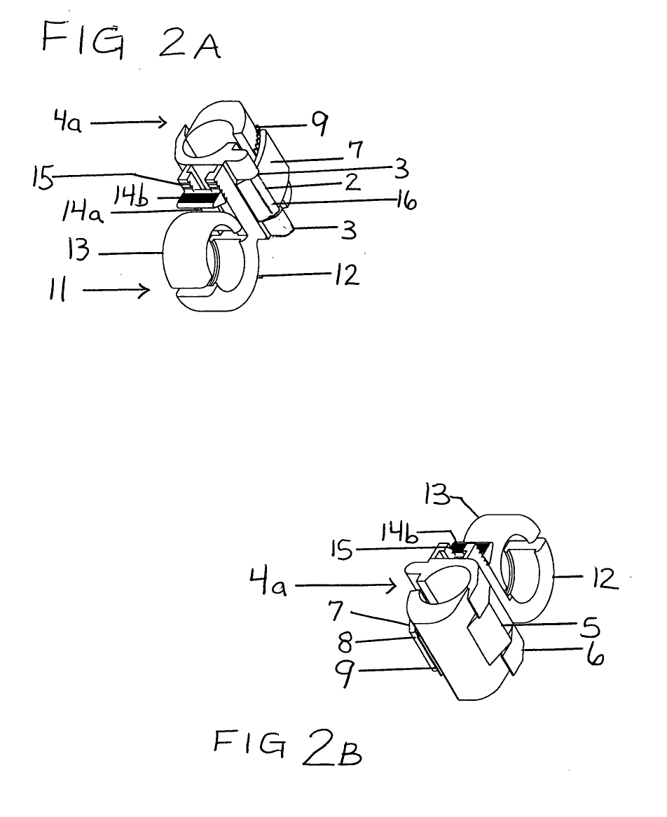

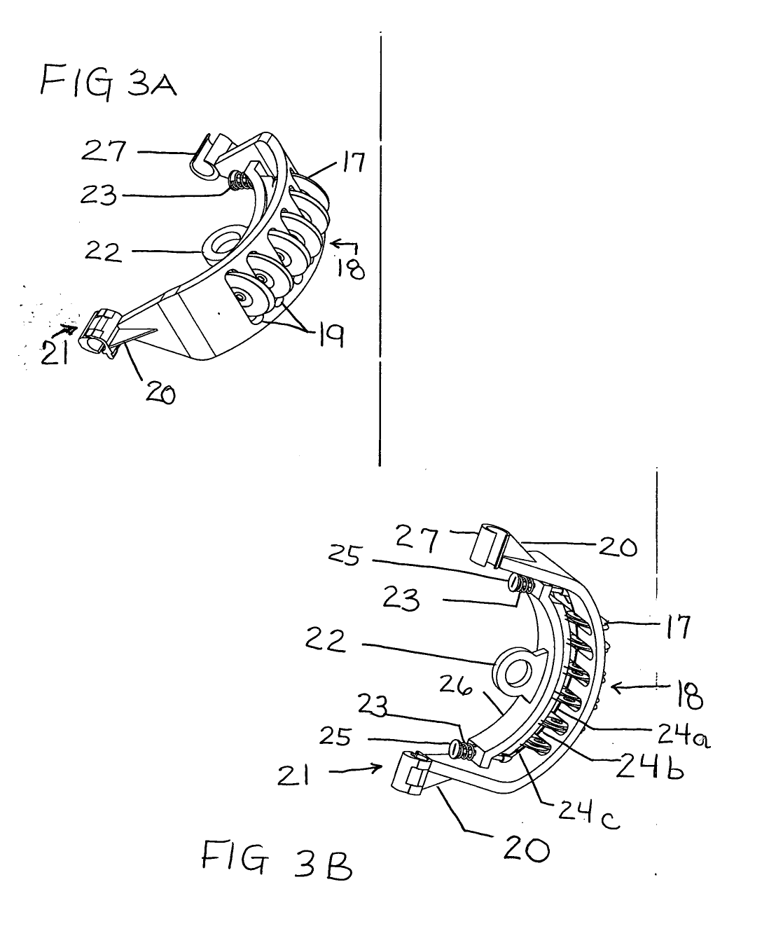

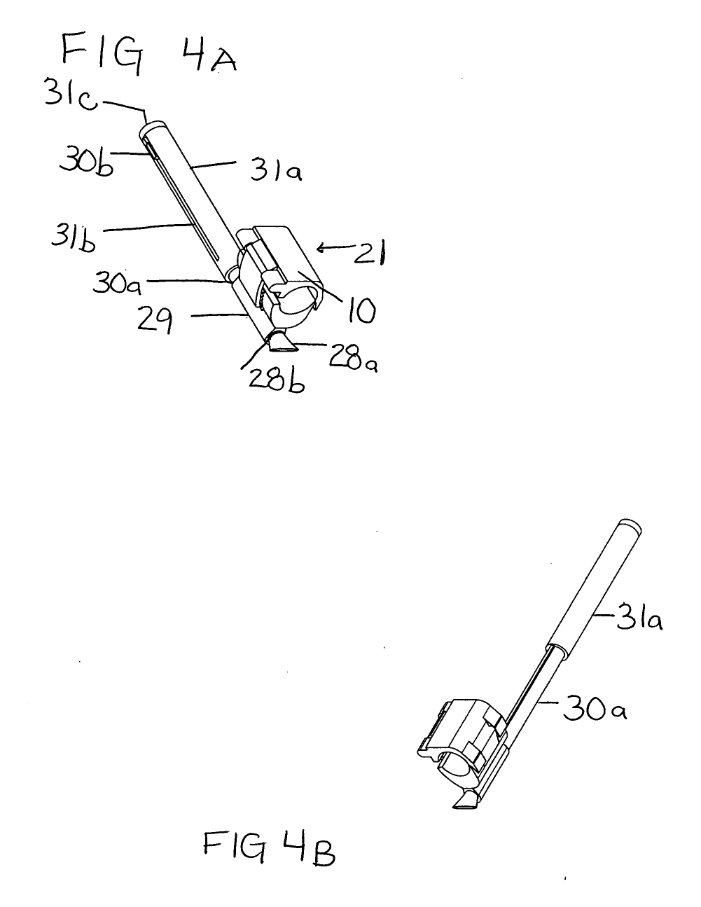

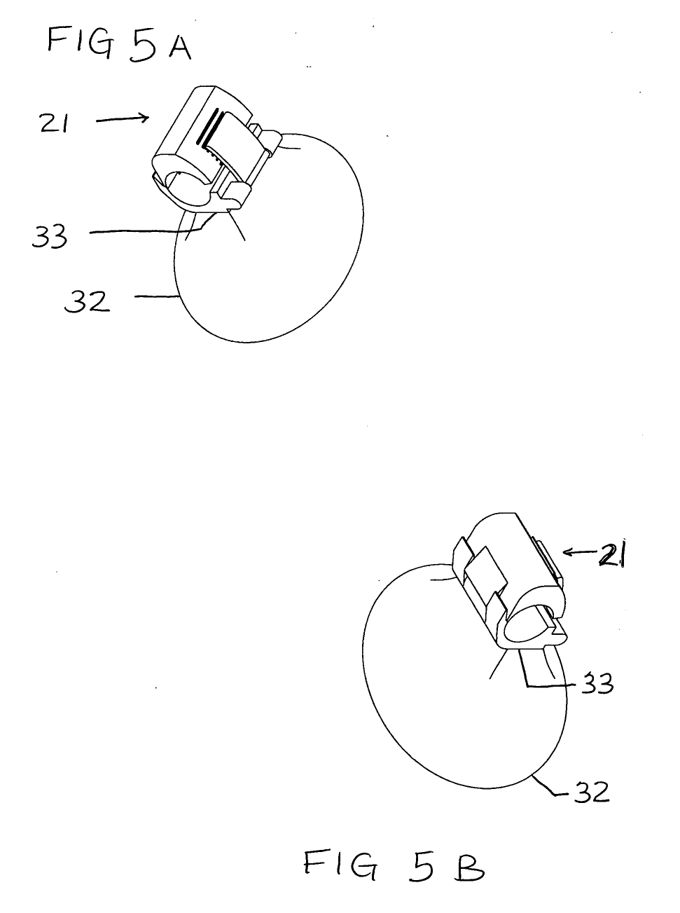

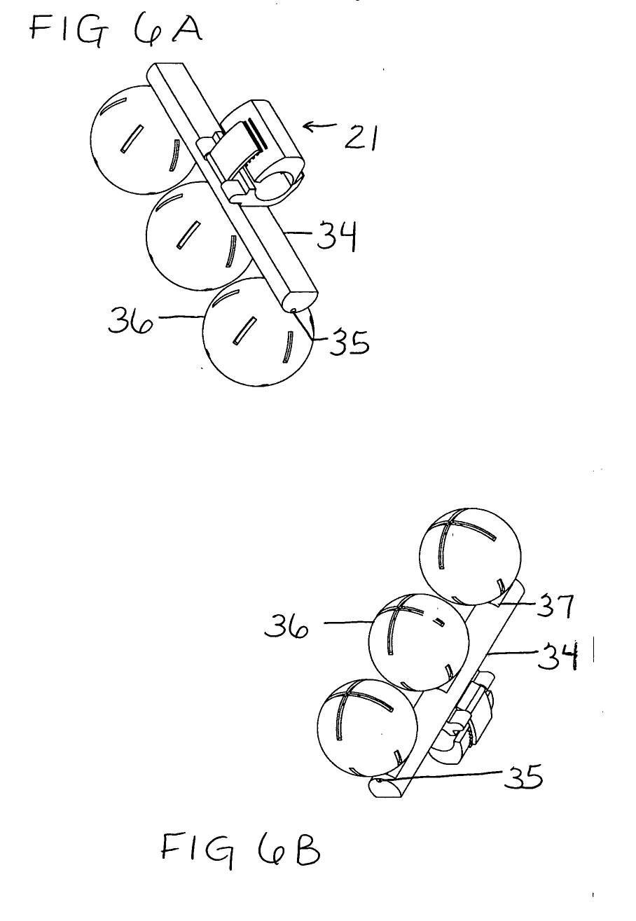

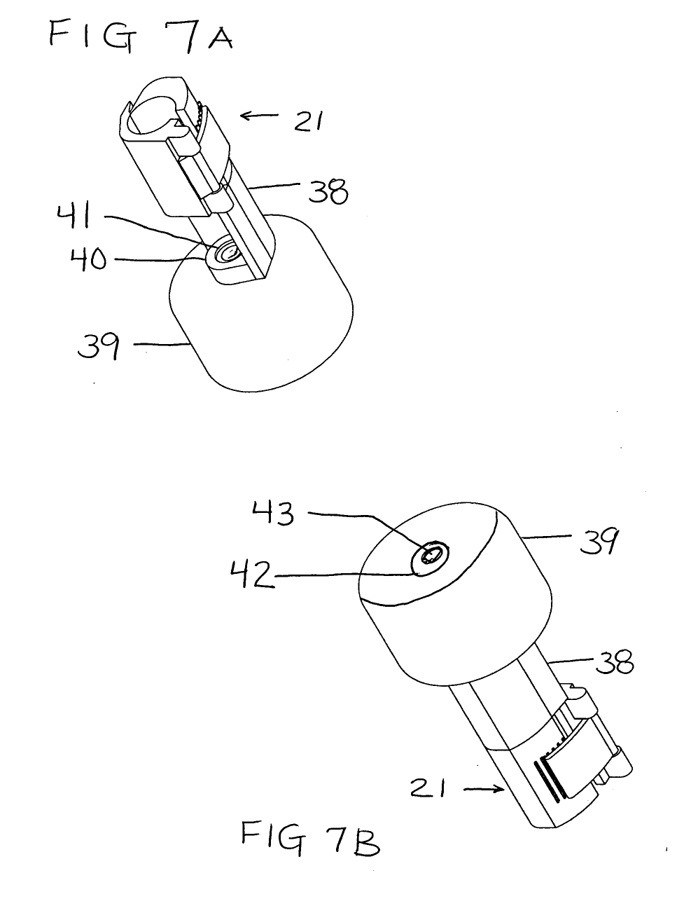

The DRAWING of this application is representative of a connector designed to temporarily grasp drumstick(s) within a secure housing. FIG. 1A; FIG. 1B; FIG. 3A Ref#27; and FIG. 3B Ref#27 relate to embodiments of the connector. The DRAWING further represents various accessories, herein referred to as gadgets. FIG. 2; FIG. 3; FIG. 4; FIG. 5; FIG. 6; and FIG. 7 illustrate embodiments of said gadgets which, for clarity, shall be referred to as: the twirl, the tambourine, the brush, the shaker, the bells, and the ma/let, respectively. Additionally, all views described, such as top, bottom, and side are subject to change according to the individual user's preference, and therefore said views do not in any way suggest a preferred position for use of the gadget/connector.

One embodiment of the connector portion of the gadget/connector, in which the connector comprises an adjustable quick-set/release clip system, is illustrated in FIG. 1A (top view) and FIG. 1B (view of underside).

One embodiment of a variation of the combination gadget/connector, the twirl, shown with connector, is illustrated in FIG. 2A (top right side view) and FIG. 2B (view of underside).

One embodiment of a variation of the combination gadget/connector, the tambourine, shown with connector, is illustrated in FIG. 3A (view from upper side) and FIG. 3B (view of under-side).

One embodiment of a variation of the combination gadget/connector, the brush, shown with connector, is illustrated in FIG. 4A (view with slide in forward position) and FIG. 4B (view with slide pulled back).

One embodiment of a variation of the combination gadget/connector, the shaker, shown with connector, is illustrated in FIG. 5A (top view) and FIG. 5B (bottom view).

One embodiment of a variation of the combination gadget/connector, the bells, shown with connector, is illustrated in FIG. 6A (top view) and FIG. 6B (bottom view).

One embodiment of a variation of the combination gadget/connector, the mallet, shown with connector, is illustrated in FIG. 7A (bottom view) and FIG. 7B (view from top left side).

### LIST OF REFERENCE NUMBERS

1 Fastener
2 Pivot Point
3 End Cap
4 Drumstick Gripping Surface
5 Hinge
6 Brake
7 Quick-Release Clip
8 Gripping Rim
9 Ridges
12 Stationary Portion of Ring-Holder
13 Sliding Portion of Ring-Holder
14 Sliding Tab
15 Grooves
16 Stop
17 Jingles
18 Tambourine Frame
19 Slots
20 Support Spine
21 Connector Portion
22 Finger Grip
23 Spring
24 Jingle Filament
25 Hanging Pin
26 Damper Frame
27 Slide Connector
28 Flange
29 Barrel Gripper
30 Barrel
31 Slide Bar
32 Enclosed Chamber
33 Attachment Platform
34 Attachment Bar
35 Mounting Filament
36 Jingle Bell
37 Cavity
38 Extension
39 Mallet Head
40 Mounting Surface
41 Nut
42 Washer
43 Bolt

### DETAILED DESCRIPTION:

The products depicted in this application shall be comprised of materials to be selected from the groups including but not limited to plastics, rubber, foam, metal, adhesives and bonding agents, pigment, and other such materials as would be commonly used in the manufacture and assembly of similar products. The manufacture process of the products depicted in this application shall be by and through the such means as molding, injection molding, or other similar process, and shall progress on to assemblage of the various parts and/or as set forth in the individual descriptions to follow. Use of the products shall be by the (temporary) attachment to drumstick(s) that will then be shaken or struck against a drum, wood block, or other such percussion instrument or surface chosen, or by some other method to create the desired sound; or twirled by the drummer to create visual effect and/or as set out below.

FIG. 1A shows a top view of the connector portion of the combination gadget/connector construed in accordance with one embodiment. Said connector is approximately 1-½″w×⅞″h×⅞″d. The fastener 1 of the connector has an adjustable quick-set/release connecting mechanism, the clip 7 supported between two end caps 3. The gripping rim 8 hooks under the edge of one of a plurality of grooves 9, said grooves to be chosen between by user dependant upon the size of drumstick being fitted within the drumstick holder 4a. The interior walls of said drumstick holder 4a, being lined or coated with an expanding material or device, forming a drumstick gripping surface 4b, and thus, whether or not a drumstick is being held by the connector, enable the user to gently squeeze the connector, thereby causing the gripping rim 8 of the quick-set/release clip 7 to be disengaged from the groove 9, turn at its pivot point 2, and thus flip open. As the quick-set/release clip 7 is disengaged, the hinge 5 allows the drumstick holder 4a to open releasing said drumstick. The brake 6 of the hinge 5 controls the degree to which the drumstick holder 4a can ‘open’. From the open position, a drumstick can be placed between the sections of the drumstick holder 4a, then, using one hand, the sides of said holder can be quickly brought together, and the quick set/release clip 7 brought down (using the thumb) so that the gripping rim 8 of the quick-set/release clip 7 grasps the appropriate groove 9, based upon the size of drumstick being used.

FIG. 1B shows a bottom view of the connector portion of the combination gadget/connector. The end caps 3 and the pivot point 2 are elements of the fastener 1 and said end caps 3 are molded as portions of the drumstick holder 4a. The bottom section of the hinge 5 lies between two brakes 6, said hinge and brakes being on the underside of the connector. The gadget attachment surface 10 is utilized for various embodiments of the gadgets and is designed for connecting the various gadgets during the manufacture/assembly process by means of appropriate material(s) selected from the group comprising glues, adhesives, screws, bolts, pins, or other such materials.

FIG. 2A shows a view from the top right of one variation of the combination gadget/connector, the twirl In addition to the grooves 9, the quick-set/release clip 7, the end caps 3, and pivot point 2 the fastener portion displays a stop 16, designed to control the extent to which the quick-set/release clip 7 can open, thereby keeping said quick-set/release clip 7 within reach for the user to attach the drumstick holder 4a to a drumstick through a simple, one-handed motion. Attached to the connector utilizing the gadget attachment surface 10 is the adjustable ring holder 11 being made up of the stationary portion of ring holder 12 and the sliding portion of ring holder 13. Said sliding portion of ring holder 13 comprises the sliding bar 14a and the adjustment tab 14b. One of a plurality of grooves 15 may be selected from in order to set the ring holder 11 in position to hold and secure a spinning ring or other such rotation device (not shown). When fitted securely on the user's preferred finger, and usually between the first and second knuckles, the inside layer of the spinning ring shall remain stationary. The outside layer of the spinning ring, fitted snuggly within the ring holder 11 will spin freely and thus enable the user to twirl the drumstick.

FIG. 2B shows a view the underside of one variation of the combination gadget/connector, the twirl The straight part of the stationary portion of the ring holder 12 is attached to the drumstick holder 4a during the process of assembly. Shown are the hinge 5 and brakes 6, the fastener ridges 9 and the gripping rim 8 of the quick-set/release clip 7 which are components of the connector portion of the combination gadget/connector. A plurality of grooves 15 and an adjustment tab 14b for the sliding portion of ring holder 13b are components of the gadget portion of the gadget/connector.

FIG. 3A shows a view from the top of one variation of the combination gadget/connector, the tambourine, construed in accordance with one embodiment. The connector portion 21 is depicted in this view and is as described relating to FIG. 1A and FIG. 1B. The gadget portion of this variation is comprised by but not limited to a plurality of jingles 17 selected from a group of jingles, bells, cymbals and other such objects, said jingles 17, being separated according to one embodiment into pairs and loosely mounted by a filament (not shown in this view) between slots 19 within the frame 18 of one embodiment of a design for a tambourine gadget. Said frame 18 is attached during assembly to the to the connector portion 21 of the combination gadget/connector by the same or similar means as set forth in the description for FIG. 1B. The frame 18 is strengthened by means of support spine(s) 20. The opposite end of said frame 18, is attached to a slide-on mechanism for connecting to a drumstick, the slide connector 27 which comprises, in accordance with one embodiment, a tubular coupling with a split/open side edge to allow for insertion of a drumstick, said slide connector 27 being comprised of materials to be selected from the group including plastics, rubber, foam, metal, and other such materials and to be lined or coated with appropriate material or device as required to secure drumstick. The finger grip 22 and spring(s) 23 are components of a jingle-dampening system (not fully shown in this view) and are compatible for use with hands of varying size and strength. The jingles are positioned in such a way that the tambourine frame 18 would most often be played on the underside of the drumstick and toward the end where the drummer's hand would normally be engaged, thus allowing for a comfortable grip. Notably, while the embodiment of the connector depicted in FIG. 1 and FIG. 2 is the preferred embodiment for being adaptable to drumsticks of different sizes, the slide connector 27 is the preferred embodiment in regards to costs involved in manufacture and assembly. In the tambourine gadget illustration, both embodiments of the connectors are utilized making both embodiments significant.

FIG. 3B shows a view from the underside of one variation of the combination gadget/connector, the tambourine. The connector portion 21 depicted at the lower extreme of this view is as described relating to FIG. 1A and FIG. 1B. A second and separate connector portion, a slide connector 27, is depicted at the upper extreme of this view and is as set forth in FIG. 3A. The gadget portion of this variation is comprised of but not limited to a plurality of jingles 17 which are loosely mounted to a tambourine frame 18 between slots (not shown in this view) by jingle filament 24a, such as wire. Said jingles 17 are mounted during assembly by said jingle filament 24a during assembly with said filament resting in a channel 24b and secured by set screw(s) 24c. Said tambourine frame 18 is strengthened by support spine(s) 20. Further comprising the embodiment is a finger-manipulated spring-action damper system. Said damper system is comprised of but not limited to a damper frame 26 being covered, coated, or lined with a dampening agent chosen from the group of materials such as felt, rubber, and foam. Further comprising said dampening system are hanging pins 25, springs 23, and a finger grip 22 for engaging and disengaging said tambourine jingles while they are attached to the drumstick.

FIG. 4A shows a top view of the brush, one variation of the combination gadget/connector, of which the strands comprising the brush (not shown) would be fully engaged for play. The collection of strands comprising the brush are not shown but shall extend from the flange 28a. Said gadget/connector being construed in accordance with one embodiment and comprised of materials to be selected from the group including plastics, rubber, foam, metal, bamboo, wood, and other such materials. The connector portion 21 is depicted in this view and is as described relating to FIG. 1A and FIG. 1B. The gadget portion is attached to the connector portion during assembly by means as described in FIG. 1B, however, according to this embodiment, said portions are joined at the exterior surface of the connector portion that is opposite the surface utilized in other embodiments or variations as the gadget attachment surface 10. The gadget portion of this variation is comprised of but not limited to a removable flange 28a having male threads upon its rounded rear-most surface (not shown), being removable by means of said threads from the barrel gripper 29 to allow for ease of changing between brush options. Said barrel gripper 29 having at flange end female threads (not shown) and said flange being secured by use of an o-ring 28b. Brushes (not shown) are contained within a barrel 30a. Brush strands shall be attached to the inside portion of the interchangeable cap 31c during the manufacture/assembly process by simple design to include but not be limited to use of materials from the groups comprising plastics, rubber, and metal crimps; said brushes, comprised of a variety of options being selected from various materials from the groups including wire, plastic, metal, rubber, bamboo, and wood. The interchangeable cap 31c thereby provides limitless options for brush sounds. Said brushes are further adaptable by means of a sliding device comprising a slide bar 31a and a barrel tab 30b, with the barrel tab 30b protruding through a slit 31b in the slide bar 31a. Said brushes are readily adjusted by the user holding said slide bar 31a in one hand and engaging said barrel tab 30b with one finger/thumb of the opposite hand causing the brush strands to be slid inward or outward through the flange 28a. Said slide bar 31a can be stopped/set at any position over the barrel 30a, thus giving the user numerous options for adding minimal, moderate, or full use of the brush alone or in synchronization with the drumstick.

FIG. 4B shows a top view of one variation of the combination gadget/connector, the brush, A slide bar 31a is shown fully disengaged, thereby completely enclosing the strands of the brush (not shown) within a barrel 30a.

FIG. 5A reveals a top side view of one variation of the combination gadget/connector, the shaker, construed in accordance with one embodiment. The connector portion 21 is as described above for FIG. 1A and FIG. 1B. An enclosed chamber 32 is partially filled, with a predetermined amount of slag-type particles. In accordance with this embodiment, said slag material is inserted into the enclosed chamber during manufacture/assembly through an opening in the molded attachment platform 33 and prior to attachment of the connector portion 21. Dependant upon the slag-type material selected, an assortment of shaker sounds can be created according to this embodiment. In addition to the various gadget sounds being utilized along with the striking of the drumstick, certain gadgets can be used separately, struck against a variety of surfaces, or utilized alternately to the drumbeat.

FIG. 5B reveals a bottom side view of one variation of the combination gadget/connector, the shaker. The connector portion 21 is shown along with the enclosed chamber 32 and the attachment platform 33.

FIG. 6A reveals a top side view of one variation of the combination gadget/connector, the bells, being construed in accordance with one embodiment. The connector portion 21 is as described above for FIG. 1A and FIG. 1B. A mounting filament 35 runs through the attachment bar 34, with said filament loosely securing a plurality of bells to the attachment bar 34. Different sizes bells provide additional options.

FIG. 6B reveals a side view of one variation of the combination gadget/connector, the bells. The cavity 37 within the attachment bar 34 allows for loops (not shown) on the underside of the bell(s) 36 to be attached by means of a mounting filament 35.

FIG. 7A shows a side view of one variation of the combination gadget/connector, the mallet The connector portion 21 is as described above for FIG. 1A and FIG. 1B. A mounting surface 40 is contained within an extension 38 being adjacent to the connector portion 21. An interchangeable mallet head 39 is comprised of various selections from the group of materials including but not limited to felt, rubber, plastic, and wood, said mallet head being attached to the extension by means of such components as a bolt (not shown in this view), a rubber washer (not shown in this view), and a nut 41. Further, said extension 38 is attached to the connector portion 21 during manufacture/assembly by means of materials selected from the group including glues, adhesives, and other such materials.

FIG. 7B shows a top view of one variation of the combination gadget/connector, the mallet The interchangeable mallet head 39 is temporarily attached to the connector portion 21 by means of the extension 38 which serves to join the parts together utilizing side of the connector portion and a side of the extension as mounting surfaces. The preferred use of the embodiment is at the hand end of the drumstick as opposed to the striking end so that the drumstick can be rotated in the hand to quickly change from using the drumstick to using the mallet. The removable mallet head 39 is held in place by means by a bolt 43, a nut 41, and a washer 42 or other similar components.

1. A combination gadget/connector of which there are numerous variations, each comprising a performance-enhancing accessory; and a light-weight, compact holder for a drumstick, baton, or similar item which can quickly be added to or removed from said drumstick or similar item.

2. The device of claim 1 wherein said gadget/connector comprises an adjustable quick-set/release connecting mechanism; and a rotation device for enabling twirling of said drumstick.

3. The device of claim 1 wherein said gadget/connector comprises an adjustable quick-set/release connecting mechanism; a plurality of tambourine jingles; and a finger-manipulated spring-action system for engaging and disengaging said tambourine jingles while they are attached to said drumstick.

4. The device of claim 1 wherein said gadget/connector comprises an adjustable quick-set/release connecting mechanism; a brush comprised of interchangeable collections of strands selected from the group consisting of wire, plastic, wood, and other such materials; and a sliding flange for adjusting the audio output of said collection of strands.

5. The device of claim 1 wherein said gadget/connector comprises an adjustable quick-set/release connecting mechanism; an enclosed chamber; and slag particles selected from the group consisting of metal, rubber, plastic, and other comparable materials.

6. The device of claim 1 wherein the gadget/connector comprises an adjustable quick-set/release connecting mechanism; and a plurality of jingle bells.

7. The device of claim 1 wherein said gadget/connector comprises an adjustable quick-set/release connecting mechanism; and an interchangeable mallet head selected from the group consisting of felt, rubber, wood, plastic, or other such materials.

8. The device of claim 1 wherein said gadget/connector comprises a slide-on connector; and a rotation device which enables twirling of said drumstick.

9. The device of claim 1 wherein said gadget/connector comprises a slide-on connector; a plurality of tambourine jingles; and a finger-manipulated spring-action damper system for engaging and disengaging said tambourine jingles while they are attached to said drumstick.

10. The device of claim 1 wherein said gadget/connector comprises a slide-on connector; a brush comprised of interchangeable collections of strands selected from the group consisting of wire, plastic, wood, and other such materials; and a removable flange for adjusting the audio output of said collection of strands.

11. The device of claim 1 wherein said gadget/connector comprises a slide-on connector; an enclosed chamber; and slag particles selected from the group consisting of metal, rubber, plastic, and other comparable materials.

12. The device of claim 1 wherein said gadget/connector comprises a slide-on connector; and a plurality of jingle bells.

13. The device of claim 1 wherein said gadget/connector comprises a slide-on connector; and an interchangeable mallet selected from the group consisting of felt, rubber, wood, plastic, or other such materials.

14. A connector comprising a light-weight, compact holder for a drumstick, baton, or similar item designed to be added to or removed from said item by means of an adjustable quick-set/release connecting mechanism.

15. A connector comprising a light-weight, compact holder for a drumstick, baton, or similar item designed to be quickly added to or removed from said item by means of a slide-on connecting mechanism.

16. An accessory or gadget to be utilized along with a drumstick, baton, or similar item for which there are numerous variations.
